(19) United States
(12) Patent Application Publication
(10) Pub. No.: US 2024/0300024 A1
(43) Pub. Date: Sep. 12, 2024

(54) RECOATER FORCE SENSOR ARRAY FOR SPATIAL AND TEMPORAL IN-SITU POWDER SPREADING QUALITY AND SURFACE DEFECT MONITORING

(71) Applicant: Divergent Technologies, Inc., Los Angeles, CA (US)

(72) Inventors: Gordon Tajiri, Los Angeles, CA (US); Michael Thomas Kenworthy, Rancho Palos Verdes, CA (US); Jason Scott, Los Angeles, CA (US); Ted Wagner, Los Angeles, CA (US)

(21) Appl. No.: 18/597,267

(22) Filed: Mar. 6, 2024

Related U.S. Application Data
(60) Provisional application No. 63/450,352, filed on Mar. 6, 2023.

(51) Int. Cl. B22F 12/67; B22F 10/28; B22F 10/80; B22F 12/90; B33Y 30/00; B33Y 50/02

(52) U.S. Cl. CPC B22F 12/67; B22F 10/28; B22F 10/80; B22F 12/90; B33Y 30/00; B33Y 50/02

(57) ABSTRACT

The present aspects include a recoater blade system. The recoater blade system includes a blade body with a longitudinal length between a first end and a second end, and a sensor device associated with the blade body. The sensor device is configured to receive inputs relating to characteristics of a powder bed. The inputs may include drag force of the blade body across the powder bed and impact force on the blade body, and these inputs may determine the spreading quality of the blade body and any surface defects that may be present.

### CROSS REFERENCE TO RELATED APPLICATIONS

This application claims priority to U.S. Provisional Application No. 63/450,352 titled “RECOATER FORCE SENSOR ARRAY FOR SPATIAL AND TEMPORAL IN-SITU POWDER SPREADING QUALITY AND SURFACE DEFECT MONITORING” filed Mar. 6, 2023, which is assigned to the assignee hereof, and incorporated by reference in its entirety as if fully set forth herein.

### TECHNICAL FIELD

The present disclosure generally relates to a sensor array system incorporated into a standard compliant polymer recoater blade for additive laser powder bed fusion printers.

### BACKGROUND

Many current recoater blades include standard silicone recoater blades that can locally conform to process weld defects that protrude above the desired metal powder height. These defects often have sharp geometries that tear and gradually destroy the surface of the polymer blade. Typical life of these blades is usually 1 to 3 builds. Failure therefore often occurs during a printer build, causing a significant loss in overall productivity and a significant amount of material waste. The recoater blade system currently in place can therefore result in extended amounts of labor, cost of materials and can result in a lack of efficiency. This makes the current recoater blade systems in place a bad choice for modern additive laser powder bed fusion printers.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to one example, a recoater blade system comprising: a recoater blade including a blade body with a longitudinal length between a first end and a second end; and a sensor device associated with the blade body, wherein the sensor device is configured to receive input relating to a powder bed characteristic.

Another example aspect includes, a recoater blade system wherein the sensor device is configured to measure a drag force of the blade body across the powder bed.

Another example aspect includes, a recoater blade system wherein the powder bed characteristic comprises a spreading quality of the blade body.

Another example aspect includes, a recoater blade system wherein the sensor device is configured to measure an impact force on the blade body.

Another example aspect includes, a recoater blade system, wherein the powder bed characteristic comprises a surface defect in the powder bed.

Another example aspect includes, a recoater blade system, wherein the powder bed characteristic comprises a spreading quality of the blade body and a surface defect in the powder bed, and wherein the sensor device is configured to measure a drag force of the blade body across the powder bed and to measure an impact force on the blade body.

Another example aspect includes, a recoater blade system, wherein the sensor device is mounted on or adjacent to the blade body.

Another example aspect includes, a recoater blade system, wherein the sensor device comprises at least a tactile sensor or a non-tactile sensor.

Another example aspect includes, a recoater blade system, wherein the sensor device comprises an array of sensors that extend longitudinally between the first end and the second end of the blade body.

Another example aspect includes, a recoater blade system, wherein the blade body comprises a mounting surface spaced apart from a powder-spreading surface, wherein the mounting surface and the powder-spreading surface each extend longitudinally between the first end and the second end, and wherein the array of sensors extends longitudinally on or adjacent to the mounting surface.

Another example aspect includes, a recoater blade system, wherein each sensor of the array of sensors are spaced apart and located at a known position along the mounting surface.

Another example aspect includes, a recoater blade system, wherein the array of sensors is located on the mounting surface in a position substantially opposing the powder-spreading surface.

Another example aspect includes, a recoater blade system, wherein the blade body further comprises a leading edge and a trailing edge connected by the powder-spreading surface, wherein the array of sensors is located on or adjacent to at least the leading edge or the trailing edge.

Another example aspect includes, a recoater blade system, wherein the array of sensors comprises a first number of sensors based on a first hardness of the blade body, and wherein the array of sensors comprises a second number of sensors based on a second hardness of the blade body, wherein the first number of sensors is greater than the second number of sensors when the first hardness is less than the second hardness.

Another example aspect includes, a recoater blade system, wherein the sensor device comprises a plurality of arrays of sensors.

Another example aspect includes, a recoater blade system, wherein a first array of sensors of the plurality of arrays of sensors is mounted on a first axis extending between the first end and the second end of the blade body, wherein a second array of sensors of the plurality of arrays of sensors is mounted on a second axis spaced apart from the first axis and extending between the first end and the second end of the blade body.

Another example aspect includes, a recoater blade system, wherein each sensor of the first array of sensors is offset along the longitudinal length of the blade body from each sensor of the second array of sensors.

Another example aspect includes, a recoater blade system, wherein the sensor device is configured to transmit measurement information relating to the powder bed characteristic.

Another example aspect includes, a recoater blade system, wherein the measurement information causes a change in operation of an additive manufacturing system in which the recoater blade system is mounted or a replacement of the recoater blade.

Another example aspect includes, a recoater blade system, wherein the change in operation of the additive manufacturing system comprises at least changing a power of a laser applied to a specific area of a surface of a powder bed of the additive manufacturing system corresponding to the powder bed characteristic, changing an environmental condition associated with the powder in the powder bed, adding additional powder to the powder bed, or canceling operation of the laser.

Another example aspect includes, an additive manufacturing system, comprising: a build surface configured to hold a powder bed of a powder material; a laser configured to irradiate a surface of the powder bed to form a portion of an additively manufactured part; a recoater blade system, comprising: a recoater blade including a blade body with a longitudinal length between a first end and a second end, wherein the recoater blade is configured to smooth the surface of the powder bed; and a sensor device associated with the blade body, wherein the sensor device is configured to receive input relating to a powder bed characteristic, and to transmit measurement information relating to the powder bed characteristic; and a controller configured to: receive the measurement information relating to the powder bed characteristic; and cause at least a change in operation of the additive manufacturing system or an indication for replacement of the recoater blade based on the measurement information.

Another example aspect includes, an additive manufacturing system, wherein the change in operation of the additive manufacturing system comprises at least changing a power of a laser applied to a specific area of a surface of a powder bed of the additive manufacturing system corresponding to the powder bed characteristic, changing an environmental condition associated with the powder in the powder bed, adding additional powder to the powder bed, or canceling operation of the laser.

Another example aspect includes, an additive manufacturing system, wherein the controller is configured to: determine a baseline characteristic associated with the measurement information relating to the powder bed characteristic; determine a difference between a current characteristic of the measurement information relating to the powder bed characteristic and the baseline characteristic; and trigger the change in operation of the additive manufacturing system or the indication for replacement of the recoater blade based on the difference being greater than a threshold.

### BRIEF DESCRIPTION OF THE DRAWINGS

FIG. 1 is a side cross-sectional view of a recoater blade system with a sensor device located between the base of the recoater and the recoater frame.

FIG. 2 is a side cross-sectional view of a recoater blade system with a sensor device located at the edge of the recoater blade.

FIG. 3 is a side cross-sectional view of a recoater blade system with a staggered sensor array device located between the base of the recoater and the recoater frame.

FIG. 4 is a front view of a recoater blade system.

FIG. 5 is a top view of an exemplary sensor array.

FIG. 6 is a top view of an exemplary staggered sensor array.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

A recoater blade system is an aspect of additive laser powder bed fusion printers. Specifically, the present disclosure integrates a thin-film pressure or force sensor array into a standard compliant polymer recoater blade for additive laser powder bed fusion printers. The integration of a sensor array into the recoater blade allows for measuring and recording the magnitude and location of a local transient defect or a change in local powder due to blade drag force. To further improve detection and discrimination of defects above the powder layer height, a staggered sensor array can be utilized to differentiate the vertical defect (bump) load component from the horizontal powder drag component (or other horizontal impact component).

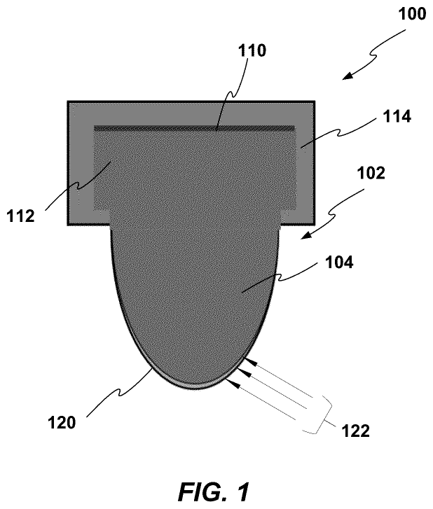

Referring to FIGS. 1-3, according to one example, a recoater blade system 100 includes a recoater blade 102 including a blade body 104 with a longitudinal length between a first end 106 and a second end 108. A sensor device 110 is further mountable to the blade body 104. The sensor device 110 is configured to receive inputs, which relate to, and provide information about the powder bed and its characteristics. The inputs received by the sensor device 110 may include drag force of the blade body 104 across the powder bed, or impact force on the blade body 104. These inputs may serve to provide information about the characteristics of the powder bed such as but not limited to the overall spreading quality of the blade body 104, and/or any surface defects in the powder bed.

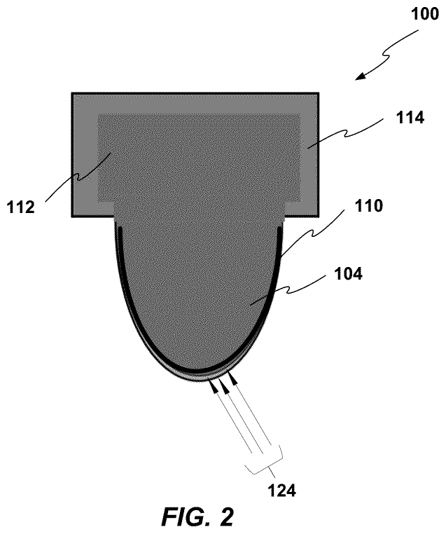

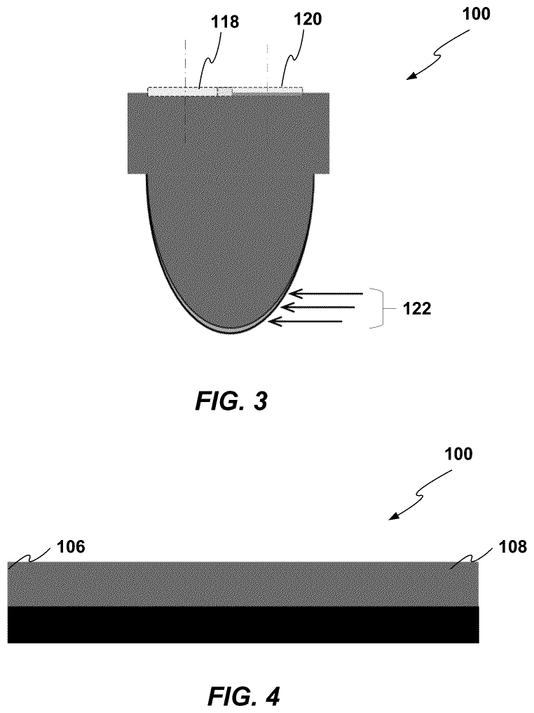

An example implementation of the sensor device 110 may include a sensor device 110, which is mounted at a given location on the blade body 104. The sensor device 110 may measure the horizontal drag force 122 (shown in FIGS. 1 and 3) on the recoater blade 102, or in other words the sensor device 110 may measure the forces on the recoater blade as it sweeps across the powder, and any resistance it may face. This measure of force may serve to indicate the overall spreading quality of powder of the blade body 104, or how smoothly and evenly the blade body 104 is spreading the powder. Similarly, the sensor device 110 may measure impact force 124 (shown in FIG. 2) on the blade body 104, this impact force may be a more substantially vertical force on the blade body 104 picked up by the sensor device 110. The impact force may indicate a surface defect in the powder bed. Further the sensor device 110 may measure both horizontal drag force on the recoater blade 102 as well as impact force, and may therefore determine the overall spreading quality as well as any surface defects in the powder bed.

The sensor device 110 may be located in a plurality of different locations on the recoater blade 102. For example, as can be seen in FIG. 1, the sensor device 110 may be mounted between the base 112 of the recoater blade 102 and the recoater frame 114. This sensor configuration would measure forces applied to the recoater blade 102 by the powder and powder bed. In this example, if the recoater blade 102 is sweeping from left to right, horizontal drag force may be encountered by the recoater blade 102. The sensors 110 located between the base 112 of the recoater blade 102 and the recoater frame 114 would pick up increased force on the left side of the sensor device 110. Alternatively, if the recoater blade 102 is sweeping from right to left then the drag force may be encountered on the opposite side of the blade 102 and the sensors located between the base 112 of the recoater blade 102 and the recoater frame 114 would pick up increased force on the right side of the sensor 110. Finally, a vertical force may be encountered by the recoater blade 102, which may indicate a defect in the powder. This vertical force may push the blade 102 straight up, or in a more substantially vertical direction, and the sensor device 110 would therefore pick up a more even force across the sensor device 110 in a substantially upward direction. This sensor configuration may be advantageous as the sensors 110 would only experience forces between the blade base 112, via the blade body 104, and the recoater frame 114. This would protect the sensor device 110 from being exposed to the powder and experiencing any damage that may be encountered by the blade body 104.

Alternatively the sensor device 110 may be located at the edge of the blade body 104 as can be seen in FIG. 2. This sensor configuration would receive input directly from the powder. For example horizontal drag force would be picked up directly by the sensor located at the edge of the blade 102 as the blade 102 is sweeping either from left to right or right to left. Specifically the sensors located at the leading edge of the blade body 104, would pick up any horizontal drag forces that may be encountered, where the trailing edge would not. Similarly a defect of the powder would cause a vertical or substantially vertical force directly onto the sensor 110 as the blade body 104 hit the defect. This sensor configuration may be advantageous as the sensors 110 would be able to pick up smaller more minute forces and may be more sensitive to drag and potential defects. Alternatively, this would expose the sensor 110 directly to the powder and may therefore cause the sensor 110 to potentially experience damage from the powder in the event of a large defect or large amount of drag force.

Based on the advantages and disadvantages of the different sensor configurations, different applications may utilize different sensor configurations or a combination of the sensor configurations. For example, an application which requires a high level of precision, and therefore requires smaller drag forces and defects to be detected may utilize a sensor device 110 located at the edge of the blade body 104. Alternatively, an application which may require less precision, therefore may not need to pick up these smaller forces and defects, and may therefore utilize a sensor device 110 located between the base 112 of the recoater blade 102 and the recoater frame 114. Further, some applications may utilize sensors at the edge of the blade body 104, as well as between the base 112 of the recoater blade 102 and the recoater frame 114 for particularly complex applications.

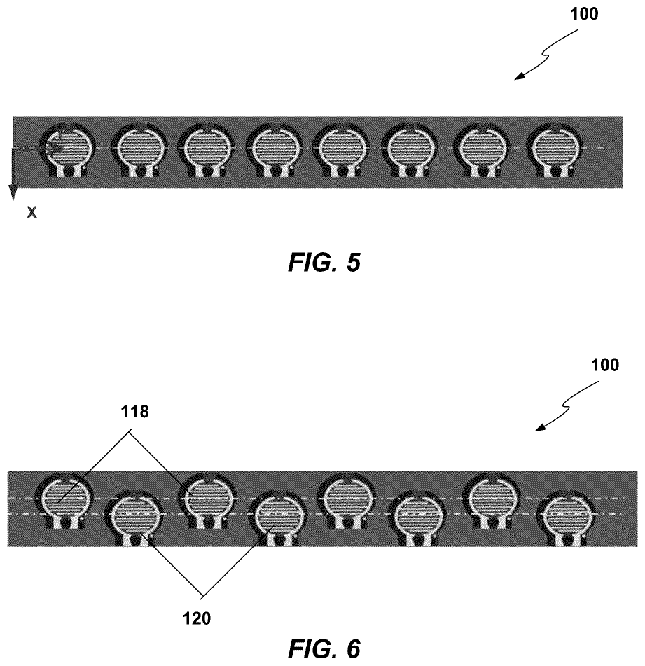

As can be seen in FIGS. 3, 5 and 6, different types of sensor arrays may be also be utilized. FIG. 5 exemplifies a thin film piezoresistive pressure sensor array, or a singular row of sensors that extend longitudinally between the first end and the second end of the blade body. This array may pick up forces, but may also not be able to determine the difference in directionality of the forces (i.e. horizontal vs. vertical forces) with a high level of precision. This sensor configuration while less accurate also requires a lower number of sensors. FIG. 6, on the other hand, exemplifies a staggered piezoresistive pressure sensor array, or plurality of sensor arrays, which are staggered from one another (this embodiment is also exemplified in FIG. 3). This staggered sensor array shown in FIG. 6, utilizes a first array of sensors 118 of the plurality of arrays of sensors mounted on a first axis extending between the first end 106 and the second end 108 of the blade body 104, wherein a second array of sensors 120 of the plurality of arrays of sensors is mounted on a second axis spaced apart from the first axis and similarly extending between the first end 106 and the second end 108 of the blade body. In other words, a first row of sensors 118 may extend along a first axis and a second row of sensors 120 may extend along a second axis parallel to the first axis. The first row of sensors 118 includes sensors spaced apart at particular intervals, and the second row of sensors 120 includes sensors spaced apart at similar intervals offset of the intervals of the first row of sensors 118. This allows for a higher range of forces to be detected. This higher range of forces can be seen, for example, in the horizontal drag force 122 shown in FIG. 3. Here, the first row of sensors 118 will pick up a higher level of force than the second row of sensors 120 as the horizontal drag force 122 will cause the blade body to want to rotate so as to put a higher level of pressure towards the side of the first sensor array 118.

Additionally the number of sensors included in the sensor device 110 may be increased or decreased depending on the particular application. A first example may include a blade body 104 made of a harder material (such as typical alloyed electrodeposited metals including but not limited to nickel, cobalt, iron or other high strength and modulus metals), and a second example may include a blade body made of a softer material (such as a polymer or a composite). In the first example, which includes a harder blade body 104, there may be a smaller number of sensors required in the sensor device 110, as the blade is less likely to encounter damage or be otherwise affected by drag and defects, and alternatively in the second example, which includes a softer blade body 104, there may be a larger number of sensors in the sensor device 110, as a softer blade may be more easily damaged thereby causing uneven powder distribution and potential defects.

The sensor device 110, as discussed above, is configured to transmit information relating to the powder bed characteristics. This information relayed by the sensor device 110 may then be utilized in the operation of the additive manufacturing system. In one example, the sensor device 110 may transmit information that determines that a new recoater blade 102 is required as the previous recoater blade 102 may have encountered damage from drag force or a defect. This change in operation is important as a damaged blade 102 may cause further defects going forward, and may lead to a defective product, which may be unusable. In a further example, the information from the sensor device may relay that a change in power from the laser may be required in order to correct a defect, or prevent future defects from occurring. Alternatively, the information may relay that additional powder, or changing the environmental condition associated with the powder in the powder bed, is needed to correct the defect, or that the laser must be disengaged all together and the printing process must be cancelled. The information obtained from the sensor device 110, as described above, is crucial in the printing process as this allows for a much more efficient printing process. Specifically, defects can be found early on in the printing process, and can therefore be corrected using one of the methods described above, among other potential corrective processes. Alternatively, in the event of a larger defect that may not be correctable, and which may not may not have been discovered without the use of the sensor device 110, the printing process can be halted and restarted without the waste of additional time and materials. The sensor device 110, is therefore key in the efficient use of time, laser power, and printing materials.

The recoater blade system 100, is further part of an additive manufacturing system. The additive manufacturing system includes a build surface configured to hold a powder bed of a powder material; a laser configured to irradiate a surface of the powder bed to form a portion of an additively manufactured part; the recoater blade system 100 as described above; and a controller. The recoater blade system 100 of the additive manufacturing system includes the recoater blade 102 including the blade body 104 with a longitudinal length between a first end 106 and a second end 108. The recoater blade 102 is configured to smooth the surface of the powder bed. The sensor device associated with the blade body, as described above, is configured to receive input relating to the powder bed characteristics, and to further transmit measurement information relating to these powder bed characteristics. The controller is configured to receive the measurement information relating to the powder bed characteristic from the sensor device 110. The controller may then cause at least a change in operation of the additive manufacturing system or an indication for replacement of the recoater blade 102 based on the measurement information. The change in operation of the additive manufacturing system by the controller may include, but is not limited to changing the power of the laser applied to a specific area of a surface of a powder bed of the additive manufacturing system corresponding to the powder bed characteristic, changing an environmental condition associated with the powder in the powder bed, adding additional powder to the powder bed, or canceling operation of the laser.

The controller is additionally configured to determine a baseline characteristic associated with the measurement information relating to the powder bed characteristic. The controller may then determine a difference between a current characteristic of the part based off of the measurement information relating to the powder bed characteristic and the baseline characteristic. Finally the controller may trigger the change in operation of the additive manufacturing system or the indication for replacement of the recoater blade based on the difference being greater than a threshold. In other words the controller may detect a difference between the information received by the sensor, as to the current condition of the part (i.e. what has been printed) and/or of the powder bed, and what is supposed to be printed. The controller may then determine a course of action to correct the difference.

In a first example the controller may determine that the recoater blade is not efficiently spreading the powder based on the sensor picking up horizontal drag force. Based on the information relayed from the sensor, the controller may determine the best course of action would be to replace recoater blade, or to increase the powder in subsequent powder application, or to otherwise update the printing process. In an alternative example the controller may determine that there is a defect based on the sensor device 110 picking up an impact force, or substantially vertical force. Based on the impact force, the controller may determine the best method of correcting the defect, or may determine that the defect may not be correctable and that the printing process must be halted. The critical nature of the sensor device 110, allows for an efficient printing process that can avoid the use of unnecessary powder and other printing resources.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the disclosure have been described above, it is to be understood that variations and modifications will be apparent to those skilled in the art without departing from the scope and spirit of the disclosure.

1. A recoater blade system, comprising:
a recoater blade including a blade body with a longitudinal length between a first end and a second end; and
a sensor device associated with the blade body, wherein the sensor device is configured to receive input relating to a powder bed characteristic.

2. The recoater blade system of claim 1, wherein the sensor device is configured to measure a drag force of the blade body across the powder bed.

3. The recoater blade system of claim 2, wherein the powder bed characteristic comprises a spreading quality of the blade body.

4. The recoater blade system of claim 1, wherein the sensor device is configured to measure an impact force on the blade body.

5. The recoater blade system of claim 4, wherein the powder bed characteristic comprises a surface defect in the powder bed.

6. The recoater blade system of claim 1, wherein the powder bed characteristic comprises a spreading quality of the blade body and a surface defect in the powder bed, and wherein the sensor device is configured to measure a drag force of the blade body across the powder bed and to measure an impact force on the blade body.

7. The recoater blade system of claim 1, wherein the sensor device is mounted on or adjacent to the blade body.

8. The recoater blade system of claim 1, wherein the sensor device comprises at least a tactile sensor or a non-tactile sensor.

9. The recoater blade system of claim 1, wherein the sensor device comprises an array of sensors that extend longitudinally between the first end and the second end of the blade body.

10. The recoater blade system of claim 9, wherein the blade body comprises a mounting surface spaced apart from a powder-spreading surface, wherein the mounting surface and the powder-spreading surface each extend longitudinally between the first end and the second end, and wherein the array of sensors extends longitudinally on or adjacent to the mounting surface.

11. The recoater blade system of claim 10, wherein each sensor of the array of sensors are spaced apart and located at a known position along the mounting surface.

12. The recoater blade system of claim 10, wherein the array of sensors is located on the mounting surface in a position substantially opposing the powder-spreading surface.

13. The recoater blade system of claim 10, wherein the blade body further comprises a leading edge and a trailing edge connected by the powder-spreading surface, wherein the array of sensors is located on or adjacent to at least the leading edge or the trailing edge.

14. The recoater blade system of claim 9, wherein the array of sensors comprises a first number of sensors based on a first hardness of the blade body, and wherein the array of sensors comprises a second number of sensors based on a second hardness of the blade body, wherein the first number of sensors is greater than the second number of sensors when the first hardness is less than the second hardness.

15. The recoater blade system of claim 1, wherein the sensor device comprises a plurality of arrays of sensors.

16. The recoater blade system of claim 15, wherein a first array of sensors of the plurality of arrays of sensors is mounted on a first axis extending between the first end and the second end of the blade body, wherein a second array of sensors of the plurality of arrays of sensors is mounted on a second axis spaced apart from the first axis and extending between the first end and the second end of the blade body.

17. The recoater blade system of claim 16, wherein each sensor of the first array of sensors is offset along the longitudinal length of the blade body from each sensor of the second array of sensors.

18. The recoater blade system of claim 1, wherein the sensor device is configured to transmit measurement information relating to the powder bed characteristic.

19. The recoater blade system of claim 18, wherein the measurement information causes a change in operation of an additive manufacturing system in which the recoater blade system is mounted or a replacement of the recoater blade.

20. The recoater blade system of claim 18, wherein the change in operation of the additive manufacturing system comprises at least changing a power of a laser applied to a specific area of a surface of a powder bed of the additive manufacturing system corresponding to the powder bed characteristic, changing an environmental condition associated with the powder in the powder bed, adding additional powder to the powder bed, or canceling operation of the laser.

21. An additive manufacturing system, comprising:
a build surface configured to hold a powder bed of a powder material;
a laser configured to irradiate a surface of the powder bed to form a portion of an additively manufactured part;
a recoater blade system, comprising:
a recoater blade including a blade body with a longitudinal length between a first end and a second end, wherein the recoater blade is configured to smooth the surface of the powder bed; and
a sensor device associated with the blade body, wherein the sensor device is configured to receive input relating to a powder bed characteristic, and to transmit measurement information relating to the powder bed characteristic; and
a controller configured to:
receive the measurement information relating to the powder bed characteristic; and
cause at least a change in operation of the additive manufacturing system or an indication for replacement of the recoater blade based on the measurement information.

22. The additive manufacturing system of claim 21, wherein the change in operation of the additive manufacturing system comprises at least changing a power of a laser applied to a specific area of a surface of a powder bed of the additive manufacturing system corresponding to the powder bed characteristic, changing an environmental condition associated with the powder in the powder bed, adding additional powder to the powder bed, or canceling operation of the laser.

23. The additive manufacturing system of claim 21, wherein the controller is configured to:
determine a baseline characteristic associated with the measurement information relating to the powder bed characteristic;
determine a difference between a current characteristic of the measurement information relating to the powder bed characteristic and the baseline characteristic; and
trigger the change in operation of the additive manufacturing system or the indication for replacement of the recoater blade based on the difference being greater than a threshold.
